(19) United States
(12) Patent Application Publication
(10) Pub. No.: US 2014/0069266 A1
(43) Pub. Date: Mar. 13, 2014

(54) Electric Signal Generating Plectrum

(71) Applicant: Hiram Allen Philo, Boone, IA (US)

(72) Inventor: Hiram Allen Philo, Boone, IA (US)

(21) Appl. No.: 13/615,316

(22) Filed: Sep. 13, 2012

(51) Int. Cl. G10D 3/16

(52) U.S. Cl. CPC G10D 3/163
USPC 84/730; 29/25.35

(57) ABSTRACT

An electric signal generating plectrum comprises a stringed musical instrument pick conjoined with a piezoelectric transducer.

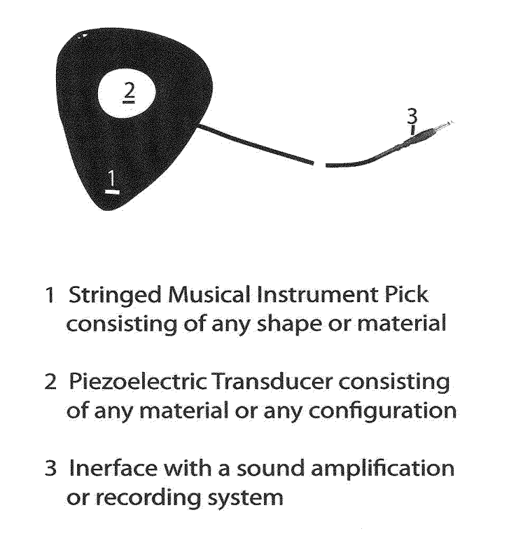

### CROSS-REFERENCE TO RELATED APPLICATIONS

None

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND FOR THE INVENTION

A common desire of many musicians is to produce sound from their acoustic stringed instruments, in live performance, which matches studio quality. As Stringed instrument amplification technology advances toward this goal, one feature of studio recording, the percussive sounds from a pick striking strings, is often missing in live performance. Some of this percussive sound emanates from the pick itself. Attempts to capture these sounds through microphones in live performance also captures and reproduces stage noise, which can promote feedback loops and distort signal clarity. Transducing vibrations directly from a pick provides an isolated signal, which can be mixed with the instrument signal for amplification. By augmenting the signals from stringed instruments with signals from their picks, this invention could potentially bring stringed instrument amplification a step closer to the stated goal of studio quality sound in a live performance setting. In addition, any number of signal alterations can be applied to the pick signal separately from the instrument signal creating new possibilities in electric and acoustic guitar effects.

Stringed instruments, and therefore their accompanying plectrums (picks) likely existed before the written word. Historical evidence from ancient Egypt and Sumer shows that stringed instruments, and their respective plectrum, were already common in 3000 BC. Existing utility patents involving musical instrument picks claim uniqueness of shape, and materials from which said picks are made. The claim of the invention described herein is independent of all such factors. An electric signal generating plectrum, as claimed herein comprises a piezoelectric transducer conjoined to a pick, regardless of said pick's shape, or material of construction. There are several patents for combining instrument picks with other inventions (examples: U.S. Pat. Nos. 4,320,689 and 7427,705), yet that art discloses no combinations of plectra with piezoelectric transducers.

The direct piezoelectric effect was first demonstrated in 1880 by the brothers Pierre Curie and Jacques Curie. Mounting a piezoelectric transducer to a musical instrument was described as early as 1924 in a patent application by Meissner, U.S. Pat. No. 1,633,186. Since then differing transducer materials and configurations have been employed in the advancement of the art of musical instrument sound reproduction utilizing piezoelectric transducers (some examples are: planar wave detecting foot pads, U.S. Pat. No. 5,212,336; films, U.S. Pat. No. 5,123,325; coaxials, U.S. Pat. No. 6,239,349; elongated beams, U.S. Pat. No. 6,605,771). An intention of this patent application is that any piezoelectric transducer comprising these variations of material or configuration, as well as any other variations, when conjoined to a musical stringed instrument pick, shall not be deemed, due to said variations, to be outside the scope of an “electric signal generating plectrum”. These said variations do not exclude a piezoelectric transducer from the scope of the invention disclosed herein, as said electric signal generating plectrum claims the conjunction of a pick with “a piezoelectric transducer consisting of any material or configuration”

Patents exist claiming conjunction of piezoelectric transducers with stringed instruments and various parts of stringed musical instruments. (Some examples are: as part of the bridge, U.S. Pat. No. 3,301,936; embedded in the body of a solid body guitar, U.S. Pat. No. 6,075,198; attached to the bridge plate, U.S. Pat. No. 6,605,771; at the junction of the neck and the body, U.S. Pat. No. 7,151,216) Yet, prior to the invention disclosed herein, no claims have been made for the conjunction of piezoelectric transducers with the picks for striking the strings of musical instruments. A close facsimile is a glove comprising piezoelectric sensors, which is worn when plucking a stringed instrument, U.S. Pat. No. 7,842,879.

### BRIEF DESCRIPTION OF THE INVENTION

An electric signal generating plectrum comprises a stringed musical instrument pick conjoined with a piezoelectric transducer.

### BRIEF DESCRIPTION OF THE DRAWING

The single diagram is a simple representation of the Electric Signal Generating Plectrum.

### DETAILED DESCRIPTION OF THE INVENTION

An electric signal generating plectrum comprises a stringed instrument pick, consisting of any size, shape, or material of construction, in conjunction with; a piezoelectric transducer, consisting of any material or configuration. The said piezoelectric transducer may be conjoined with said pick by attachment through any means including, but not limited to: soldering, or welding; or adhesive (i.e. tape or glue); or mechanically (i.e. clamps, screws, or bolts); or embedded in said pick; or by forming said pick from a surface or protrusion, which is part of said piezoelectric transducer. The signal from the invention disclosed herein is produced for transmitting to a sound amplification or recording system.

What is claimed is:

1. An electric signal generating plectrum, comprising: a musical stringed instrument pick consisting of any size, shape, or material of construction; in conjunction with a piezoelectric transducer, consisting of any material or configuration.

2. The conjunction, according to claim 1, of said pick with said piezoelectric transducer, wherein said conjunction is accomplished through any means, including but not limited to: glue; tape; any sticking substance; screws; bolts; clamps; clips; welding; soldering; any vibration conducting attachment device; embedding said piezoelectric transducer in a synthetic material from which said pick is manufactured, during said pick's manufacturing; sandwiching said transducer between composites from which said pick is manufactured, during said pick's manufacturing; inserting said piezoelectric transducer in a cavity in said pick; or by utilizing a surface or protrusion, which is part of the said piezoelectric transducer, as the said musical stringed instrument pick,
